(19) United States
(12) Patent Application Publication
(10) Pub. No.: US 2009/0054580 A1
(43) Pub. Date: Feb. 26, 2009

(54) METHOD FOR MAKING A FIBROUS INSULATING PRODUCT, SIZING STUFF AND COMPOSITION

(75) Inventors: Jacky Joachim, Gouvieux (FR); Philippe Espiard, Gouvieux (FR); Bruno Mahieuxe, Clermont (FR); Roger Gilbert, Rantigny (FR); Wolfgang Holstein, Homberg (DE); Gerald Amannt, Wilhelmsfeld (DE)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN ISOVER, Courbevoie (FR)

(21) Appl. No.: 12/194,853

(22) Filed: Aug. 20, 2008

Related U.S. Application Data
(63) Continuation of application No. 09/786,113, filed on Jun. 4, 2001, now abandoned.

(30) Foreign Application Priority Data
Sep. 1, 1998 (FR) 98/10923

(51) Int. Cl. C08K 3/34; C08G 65/48; C08L 67/00

(52) U.S. Cl. 524/443; 525/391; 525/397

(57) ABSTRACT

In order to improve the mechanical strength after ageing, particularly in a wet medium, of an insulation product, especially a thermal and/or acoustic insulation product, based on mineral wool provided with a size, a latex is incorporated in the sizing composition which contains especially a phenolic resin.

The presence of the latex allows the loss of mechanical performance after ageing to be very considerably reduced.

The sizing composition advantageously comprises a latex based on an aqueous dispersion or emulsion of a polymer phase carrying hydrophilic functional groups.

Application to the manufacture of insulation products intended to be exposed to atmospheric condensation and/or based on mineral wool of lower hydrolytic resistance.

The present invention relates to the techniques used to manufacture insulation products, especially thermal and/or acoustic insulation products, based on mineral wool. It relates more particularly to an improved size for the wool of which such a product is composed, so as to improve the mechanical strength after ageing of this product, particularly in a wet medium.

These products, which may be based on glass or rock wool, are usually in the form of rolled-up felts, of relatively rigid panels, of shells or of blankets.

The manufacture of these insulation products comprises the following steps:
the glass or rock mineral composition is melted in a suitable furnace;
the molten mineral material is taken to a fiberizing apparatus;
the molten material is transformed into filaments, especially using the known technique of centrifugal drawing over rotors or of drawing through perforated dishes, the filaments being generally drawn under the action of a blast of gas;
a sizing composition containing a thermosetting resin is sprayed onto the wool thus formed;
the sized wool is gathered on a device for taking it up in the form of a web; and
the web is subjected to a heat treatment for the purpose of curing the resin and the web is made into the desired shape.

The properties required of the end-product depend on each particular application, but it is generally desired to obtain, in addition to the insulating properties of the product, a number of mechanical characteristics, such as dimensional stability, puncture strength, tear strength, tensile strength and compressive strength.

Although it is important for these properties to remain good from the manufacture of the product until its use, in order to ensure the proper conditions for installing it on the site, it is also desirable for these properties to remain good for a certain length of time after the product has been put into place, in order to guarantee a long enough lifetime of the product.

Unfortunately, it sometimes happens that these products suffer a loss of mechanical properties after ageing, in particular when they are exposed to moisture, especially under conditions of high atmospheric condensation, for example in the case of products which are used in roofs and which are subjected to large thermal cycles.

It is also necessary, for example, to take care to avoid such losses when the composition of the mineral wool is particularly sensitive to water, for example when it is a mineral wool capable of dissolving in a physiological medium,

Document WO-A-97/21636 discloses how to improve the ageing strength in the presence of atmospheric moisture of artificial mineral fibres of the type soluble in a physiological medium (solubility of at least 20 nm/day at 7.5 pH at 37° C.) by forming a coating on the fibres which comprises an ammonium hydrogenphosphate salt or a quaternary ammonium salt or an alkali metal salt, preferably diammonium hydrogenphosphate or ammonium dihydrogenphosphate.

The ageing strength in a wet medium is estimated in this document by deducing, from pH measurements, the degree of dissolution of the fibres in immersion tests simulating accelerated ageing under normal conditions of use. Optionally, in addition to the pH measurement, the erosion of the fibres is examined under a microscope.

However, this treatment proves to be insufficient for maintaining the mechanical properties of the product after exposure to the wet medium: by carrying out mechanical strength tests on these products based on mineral wool after accelerated ageing in a wet medium, the present inventors have observed that standard ammonium-based cationic agents were unable to limit the loss of mechanical properties after exposure to the wet medium and that a phosphate such as diammonium hydrogenphosphate even had a negative effect on the mechanical properties after ageing in a wet medium in the sense that the losses in properties were greater.

The object of the invention is to obviate these drawbacks and to improve the mechanical strength after ageing, particularly in a wet medium, of insulation products based on mineral wool, or in other words to reduce the loss of mechanical properties of these products after ageing, particularly in a wet medium.

This object, as well as others which will appear later, was achieved according to the invention by adding a latex to the size during the manufacture of the products.

For this purpose, the subject of the invention is a method of improving the mechanical strength after ageing, particularly in a wet medium, of an insulation product, especially a thermal and/or acoustic insulation product, based on mineral wool provided with a size comprising a thermosetting resin, especially a phenolic resin, in which method a latex is added to the size during the manufacture of the product.

Completely surprisingly, it has been found that although, in many cases, the addition of a latex to the size did not modify, or modified only slightly, the mechanical properties, or even degraded these properties right after manufacture, it was possible to achieve a remarkable reduction in the loss of properties after ageing, particularly in a wet medium, compared with a similar product not containing the latex (standard product) and to achieve a final level of performance after ageing which is superior to the standard product.

Advantageously, this effect is observed on products based on mineral wool capable of being dissolved in a physiological medium (so-called “biosoluble” wool) which are products that ordinarily are quite sensitive to moisture, because of the quite high content of alkali metal oxides of the mineral material, often combined with a high content of boron oxide.

In the present application, the term “latex” should be understood to mean, in the usual manner, an aqueous dispersion or emulsion of one or more natural or synthetic, generally thermoplastic, polymer substances. The polymer or polymers may be self-emulsifiable, or else, if this is not so, the emulsion or dispersion is stabilized by suitable surfactants.

What proved to be advantageous, from the standpoint of the mechanical strength after exposure to the wet medium, are latices based on an emulsion or dispersion of a polymer phase carrying hydrophilic functional groups forming the interface with the aqueous phase. These functional groups are especially hydroxyl —OH, carboxyl —COOH or ester —COOR functional groups, where R denotes an alkyl group which may have especially from 1 to 5 carbon atoms. The ester functional groups are particularly preferred, especially the acetate functional group.

This result is completely surprising since it might be thought that a hydrophilic latex, by increasing the amount of water picked up by the product, would accelerate the loss of properties due to the wet medium, particularly in the case of products based on a so-called biosoluble mineral wool.

Without wishing to be bound by any scientific theory, it is possible that the hydrophilic character of the dispersed polymer phase of the latex gives the latter an advantageous affinity towards the mineral material forming the wool, possibly because of the formation of polar bonds, making the latex act, as it were, as an adhesion primer for the resin. This is because it was found, in comparative tests of the tear strength of the resin, that the prior application of a hydrophilic latex to the mineral wool gives greater adhesion of the resin of the size to the surface of the mineral material.

Whatever the situation, applying a hydrophilic latex with the size during the manufacture of the insulation product results in products which withstand the ageing in a wet medium with smaller losses in mechanical properties.

In a preferred variant, the polymer itself carries hydrophilic functional groups. Polymers in which each monomer carries at least one hydrophilic functional group prove to be advantageous in this regard, whether they be homopolymers derived from a single monomer or copolymers derived from at least two different monomers. Nevertheless, the presence of a minor comonomer not carrying a hydrophilic functional group can be tolerated.

Advantageously, the latex contains a polymer or copolymer which is of the vinyl type or of the acrylic type and/or which is derived from a carboxylic acid.

Most particularly preferred are latices of the vinyl type, particularly those having pendant ester functional groups, especially those based on vinyl acetate. Most especially preferred are latices based on a polyvinyl acetate homopolymer, but mention may also be made, as advantageous latices, of those based on a copolymer of vinyl acetate and, especially, of a (meth)acrylic ester and/or acid, of a maleic ester, of an olefin and/or of vinyl chloride.

Other useful latices may be chosen from those containing an acrylic-type polymer, especially a silanized acrylonitrile/acrylic ester or styrene/acrylic ester or acid copolymer (“silanized” means copolymerized with a monomer having an ethylenically unsaturated group carrying at least one silane or silanol functional group).

In certain cases, especially when the content of hydrophilic functional groups of the polymer is relatively low, the polymer may not have by itself a sufficiently hydrophilic character to be stable in emulsion and/or have a suitable affinity for the glass. Thus, the latex is advantageously such that the dispersed phase consists of a polymer surrounded by a protective colloid having hydrophilic functional groups (the whole forming a dispersed microparticle or nanoparticle), this colloid providing the desired hydrophilic functional groups on the surface of the suspended particle, i.e. at the interface with the aqueous phase.

In general, the colloid consists of one or more macromolecules; advantageously, it may be based on polyvinyl alcohol or on cellulose.

Thus, those latices which have proved to be particularly advantageous for reducing the loss of mechanical properties after ageing are those based on a vinyl-type polymer with a protective colloid. Mention may be made, for example, of those based on a silanized or non-silanized vinyl chloride/olefin copolymer, especially a vinyl chloride/ethylene copolymer or more preferably a vinyl chloride/vinyl laurate/ethylene terpolymer.

As a variant, the dispersed phase may consist of the said polymer surrounded by surfactant, the surface-active molecule having a first end capable of being adsorbed on the surface of the polymer phase and a second end which is hydrophilic because of the suitable functional groups, the said functional groups coming together to form the surface of the dispersed particle. The surfactant may be chosen, in a manner known per se, from molecules capable of putting the said polymer in aqueous dispersion or emulsion.

Using the latices carrying hydrophilic groups that are mentioned above, the performance after ageing of the insulation products according to the invention with regard to many mechanical properties, especially the puncture strength or the compressive strength, may be considerably improved.

However, introducing a very hydrophilic material into the insulation product may undesirably increase the amount of water capable of being held within the product, especially during storage in a wet atmosphere. In this case, it is possible to remedy this drawback by adding a water-repellent agent to the latex, such as a silicone or fluorinated compounds, while still maintaining excellent mechanical properties after ageing.

A useful latex according to the method of the invention has advantageously a glass transition temperature T_{g} of less than 100° C., particularly of less than 80° C. and especially of less than 50° C. Thus, it is thought possible that the polymer dispersed in the latex achieves sufficient plasticity in contact with the filaments of mineral wool at the time of spraying the size and/or during passage through an oven to be fixed to the mineral wool in a manner compatible with the resin of the size. Since the minimum film-forming temperature Tₘ is generally less than the glass transition temperature, it would also be possible for these latices to form a more or less uniform or continuous protective coating on the wool, which would preserve the material from attack by moisture.

Latices having a glass transition temperature T_{g} of greater than 80° C. are generally not preferred since they form very rigid, or even brittle, deposits which are not beneficial for the desired mechanical properties.

Moreover, the glass transition temperature T_{g} of the latex is advantageously at least about −5° C., particularly at least 0° C. and especially at least 5° C. Latices having a glass transition temperature T_{g} of less than −5° C. form deposits which, in the dry state, are very soft, and even tacky, and which, because of the insulation products according to the invention with regard to many mechanical properties, especially the puncture strength or the compressive strength, may be considerably improved.

However, introducing a very hydrophilic material into the insulation product may undesirably increase the amount of water capable of being held within the product, especially during storage in a wet atmosphere. In this case, it is possible to remedy this drawback by adding a water-repellent agent to the latex, such as a silicone or fluorinated compounds, while still maintaining excellent mechanical properties after ageing.

A useful latex according to the method of the invention has advantageously a glass transition temperature T_{g} of less than 100° C., particularly of less than 80° C. and especially of less than 50° C. Thus, it is thought possible that the polymer dispersed in the latex achieves sufficient plasticity in contact with the filaments of mineral wool at the time of spraying the size and/or during passage through an oven to be fixed to the mineral wool in a manner compatible with the resin of the size. Since the minimum film-forming temperature Tₘ is generally less than the glass transition temperature, it would also be possible for these latices to form a more or less uniform or continuous protective coating on the wool, which would preserve the material from attack by moisture.

Latices having a glass transition temperature T_{g} of greater than 80° C. are generally not preferred since they form very rigid, or even brittle, deposits which are not beneficial for the desired mechanical properties.

Moreover, the glass transition temperature T_{g} of the latex is advantageously at least about −5° C., particularly at least 0° C. and especially at least 5° C. Latices having a glass transition temperature T_{g} of less than −50° C. form deposits which, in the dry state, are very soft, and even tacky, and which, because of their lack of strength, do not have a significant effect on the mechanical properties after ageing in a wet medium.

The amount of latex added does not need to be very large in order to achieve a satisfactory level of improvement of the mechanical strength of the products. In general, the solids content of the latex introduced may advantageously be chosen to be less than 5% by weight with respect to the weight of the mineral wool, the latex being already effective at a content as low as 0.01%. In particular, the solids content of the latex introduced may be about 0.1 to 5%, especially 0.5 to 5%, by weight with respect to the weight of the mineral wool, but often a satisfactory result is obtained with a latex solids content of about 0.1 to 2%, or even about 0.1 to 1% and especially about 0.5 to 1%, with respect to the weight of the mineral wool.

With regard to the way of introducing the latex, the following alternative methods of implementation may be mentioned.

In a first method of implementation, the latex is mixed with the constituents of the size during the formulation of the latter, and then this modified sizing composition is applied in the usual manner to the mineral wool. This method of implementation is advantageous when the latex is compatible with the constituents of the size, i.e. the mixing does not cause any phase separation or any precipitation of solids.

In this regard, the subject of the invention is also a sizing composition for an insulation product, especially a thermal and/or acoustic insulation product, comprising a thermosetting resin and a latex.

The base formulation of the size may be as follows:
thermosetting resin, particularly of the phenol-formaldehyde type:
   50 to 90, especially 50 to 70, parts by weight of solids;
urea:
   50 to 10, especially 50 to 30, parts by weight:

with a resin+urea total=100 parts by dry weight;
ammonium sulphate:
   0 to 5, especially 1 to 3, parts by weight;
aqueous ammonia:
   0 to 10, especially 2 to 10, parts by weight (on the basis of NH₃);
silane:
   0 to 2 parts by weight;
mineral oil:
   0 to 20 parts by weight.

In a second method of implementation, applicable even when the latex is not compatible, when mixed, with the constituents of the size, the latex is applied to the mineral wool separately from the size. For example, the latex may be sprayed, as an aqueous phase, close to the size-spraying ring, especially by placing two superimposed spray rings in the path of the mineral wool towards the shake-up device, one ring (preferably the first ring in the direction of movement of the wool) being intended for the latex and the other ring being intended for the size.

Since the mineral wool thus sized is then treated in an oven in order to cure the resin of the size, care should be taken to ensure that the conditions of the oven heat treatment (temperature and residence time) do not affect the stability of the latex. As a general rule, conventional manufacturing conditions are completely compatible with the use of latices according to the invention.

The invention applies to insulation products based on all types of mineral wool, both glass wool and rock wool. It finds particularly useful application when the product consists of a glass or rock wool capable of dissolving in a physiological medium. Examples of such materials are described for instance in EP-A-0,412,878, WO-A-95/31411, WO-A-95/32927, WO-A-93/22251, EP-A-0,459,897, WO-A-96/04213 and WO-A-95/31410.

These materials generally dissolve in a saline solution simulating a physiological medium at a rate of at least 30 and especially at least 40 or 50 ng/cm² per hour, measured at pH 4.5, and at a rate of at least 30 and especially at least 40 or 50 ng/cm² per hour, measured at pH 7.5.

Among the parameters which influence the water sensitivity of these materials, mention may be made of their relatively high content of alkali metal oxides, which may be about 8 to 25% and especially 14 to 20% by weight in preferred glass compositions.

To this should be added a boron oxide content of generally about 2 to 18%, particularly at least 4% or even at least 7% and especially from 4 to 13% or even from 7 to 15% by weight.

In particular, the sodium oxide Na₂O content may be greater than or equal to 16% by weight, for example about 16.5 to 19% by weight, with a potassium oxide content of about 0.2 to 0.5% by weight.

In one particular example, according to EP-A-412,878 the composition is as follows:

| SiO₂ | 57 to 70% |
|---|---|
| Al₂O₃ | 0 to 5% |
| CaO | 5 to 10% |
| MgO | 0 to 5% |
| Na₂O + K₂O | 13 to 18% |
| B₂O₃ | 2 to 12%, |
| | especially 7 to 12% |
| F | 0 to 1.5% |
| P₂O₅ | 0 to 4% |
| impurities | <2%. |

In another particular example, according to WO-A-95/32927 the composition is as follows:

| | |
|---|---|
| SiO₂ | 45 to 60% |
| Al₂O₃ | <2% |
| CaO + MgO | 10 to 16% |
| Na₂O + K₂O | 15 to 23% |
| B₂O₃ | 10 to 18% |
| P₂O₅ | 0 to 4% |
| BaO | 0 to 1% |
| impurities | 0 to 2% |

In this regard, the subject of the invention is also an insulation product especially a thermal and/or acoustic insulation product, based on mineral wool provided with a size based on a thermosetting resin, especially a phenolic resin, in which the size contains a latex which improves the mechanical strength of the product after ageing, particularly in a wet medium, it being possible for this product to have any of the above characteristics.

In general, an improved insulation product according to the invention may have the usual density characteristics, the density in general being at least 30 kg/m³. In a preferred embodiment, the insulation product has a density of at least 50 kg/m³ and especially at least 80 kg/m³. These products, termed heavy products, are mainly used in roof-decking applications and are particularly exposed to moisture because of the thermal cycles and because of atmospheric condensation. According to the invention, their mechanical strength after ageing under these conditions remains at a good level.

Finally, the subject of the invention is the use of a latex with a size for the insulation product, especially a thermal and/or acoustic insulation product, based on mineral wool, in order to improve the mechanical strength after ageing, particularly in a wet medium, of the product.

Other features and advantages of the invention will appear in the description of the detailed examples which follow.

### EXAMPLE 1

Glass wool is manufactured using the internal centrifuging technique, in which the molten glass composition is converted into filaments by means of a tool called a centrifuging dish, comprising a basket forming the chamber for receiving the molten composition and a peripheral strip pierced with a multitude of holes; since the dish is rotated about its vertical axis of symmetry, the composition is thrown out through the holes under the action of the centrifugal force and the material escaping from the holes is drawn into filaments with the aid of a blast of drawing gas.

Conventionally, a size-spraying ring is placed underneath the fiberizing dishes so as to distribute the sizing composition uniformly over the glass wool which has just been formed.

The mineral wool thus sized is collected on a conveyor belt fitted with internal suction boxes which allow the mineral wool to be retained in the form of a felt or mat on the surface of the conveyor. The conveyor then travels through an oven where the resin of the size cures.

Compared with this conventional manufacturing technique, for the needs of this example, a second spray ring was mounted just above the sizing ring so as to spray, onto the wool, a latex composition which will be added to the size on the mineral filaments.

The composition of the glass (hereafter denoted G1) if of the type described in EP-A-0,412,878.

This is a so-called biosoluble glass, i.e. a glass capable of dissolving in a physiological medium. This type of glass is most particularly sensitive to exposure to liquid or atmospheric water for a prolonged period, it being possible for the hydrolytic attack of the glass to degrade the glass fibres with a potential loss of mechanical properties.

The composition (in parts by weight) of the size is as follows:

| | |
|---|---|
| phenol-formaldehyde resin | 55 parts by weight of |
| R1 | solids |
| (38% solids content by | |
| weight, free phenol <1.2%, | |
| free formaldehyde <7%): | |
| urea: | 45 parts by weight |
| mineral oil: | — |
| ammonium sulphate: | 3 parts by weight |
| aqueous ammonia: | 6 parts by weight |
| | (on the basis of NH₃) |
| silane: | 0 to 1 parts by |
| | weight. |

The size is diluted with water before being sprayed, the degree of dilution and the spray rate being suitable for depositing about 7 to 15%, generally about 7 to 10%, of dry matter with respect to the weight of glass wool.

The latex sprayed above the size is, in the case of this example, of the vinyl type. It is sold by Wacker under the trade mark VINNOL and consists of an aqueous dispersion of a vinyl chloride/vinyl laurate/ethylene terpolymer stabilized by a protective polyvinyl alcohol colloid. The polymer has a minimum film-forming temperature of about 2° C. and its glass transition temperature is slightly higher. The aqueous dispersion has a solids content of approximately 50% and a pH of about 4.

A reference test was carried out without spraying the latex, and two tests according to the invention were carried out with an amount of latex sprayed corresponding, respectively, to 1 and 2% of dry matter with respect to the weight of glass. For all these tests, as well as those of the following examples, the amount of water provided by the latex is taken into account in order to tailor the dilution of the size in such a way that, with or without latex, the glass wool receives the same amount of water.

The insulation product manufactured in this example is a panel having a density of about 80 kg/m³, the spraying of the latex in no way affecting achievement of the desired density.

The products obtained are subjected to measurements of the following characteristic parameters:

Immersion water uptake: This parameter characterizes the ability of the product to absorb water in the case of accidental contact with liquid water (during storage on site, for example). Indirectly, it makes it possible to quantify the degree of hydrophilicity of the additives of the glass wool.

It is measured by carrying out an immersion test according to a protocol similar to that in the ASTM C 240-72 standard.

A preweighed specimen is immersed, horizontally, in water at room temperature for 2 hours, with a water height of 30 mm above the level of the upper face of the specimen. Next, it is placed vertically on one edge in order to allow it to drain for a time of 15 minutes, after which it is weighed.

The results are expressed in terms of the mass of water in kg absorbed per m³ of volume of material. Friability: This parameter characterizes the loss of integrity of the mineral wool when the product is handled. In the context of the present invention, it is measured mainly in order to give an indication of the effectiveness of the latex deposit on the mineral filaments: a reduction in the friability is an indication that the latex has formed, at least on some of the filaments, a protective coating capable, should the filament break, of forming a kind of sheath retaining the glass in the insulation product.

It is measured in the following way: specimens are taken from the product in the form of cores 25 mm in diameter, these being cut up into approximately 3 mm slices. 3 grams of these samples are weighed out, the latter then being placed in a screen having a mesh size of 1 mm together with 4 rubber balls. The screening operation is carried out with an amplitude of agitation of 2.5 mm for 3 minutes.

The material remaining in the screen is then weighed. The results are expressed as the percentage by weight of material which has passed through the meshes of the screen with respect to the initial weight. The puncture strength (in N), the tear strength (in kPa) and the compressive strength (in kPa, for a 10% and 25% thickness reduction) are also measured in a conventional manner.

These properties are measured immediately after manufacture and after accelerated ageing (NORDTEST) for 7 days (168 hours) in an environmental chamber set to a temperature of 70° C. and a relative humidity of 90-95%.

The results are given in Table 1 below, which shows, for each test, the percentage loss of property measured with respect to the initial state after manufacture and, for each test with a latex, the percentage improvement in the property in the aged state, calculated with respect to the reference without a latex, also in the aged state.

It is apparent from this that the latex used does not affect the water uptake capability of the product very much, showing a generally hydrophobic nature of the product. When the amount of latex reaches 2%, a limited hydrophilic tendency occurs, showing the relatively hydrophilic nature of the latex, due especially to the hydrophilic functional groups of the polyvinyl alcohol.

The latex seems to have been properly fixed to the glass wool, since the latter is made less friable than in the reference product.

It is surprising to note that the latex initially does not have a significant effect on the friability, but that a positive effect gradually appears with ageing of the product, resulting, after 7 days of ageing in the wet medium, in a much smaller loss than with the reference product. The integrity of the product according to the invention in the aged state is superior to the reference product by a factor of approximately two.

TABLE 1

| | Immersion | | | | Puncture strength | | |
|---|---|---|---|---|---|---|---|
| Example 1 | water | Friability % | | | (N) | | |
| % latex/ | uptake | As | | | As | | |
| glass | kg/m³ | manufactured | Aged | Loss | manufactured | Aged | Loss |
| 0%, | 19 | 2.7 | 20 | 17.3 | 178 | 61 | −65% |
| reference | | | | | | | |
| 1% Vinnol | 19 | 2.9 | 10 | 7.1 | 187 | 90 | −52% |
| | | | (−50%) | | | (+49%) | |
| 2% Vinnol | 23 | 3.5 | 11 | 7.5 | 184 | 90 | −51% |
| | | | (−45%) | | | (+49%) | |

| | Tear strength | | | 10% compressive | | | 25% compressive | | |
|---|---|---|---|---|---|---|---|---|---|
| Example 1 | (kPa) | | | strength (kPa) | | | strength (kPa) | | |
| % latex/ | As | | | As | | | As | | |
| glass | manufactured | Aged | Loss | manufactured | Aged | Loss | manufactured | Aged | Loss |
| 0%, | 14.2 | 3.4 | −76% | 19 | 12 | −36% | 50 | 23 | −54% |
| reference | | | | | | | | | |
| 1% Vinnol | 13.6 | 5.5 | −59% | 20 | 13 | −35% | 47 | 27 | −42% |
| | | (+62%) | | | (+8%) | | | (+17%) | |
| 2% Vinnol | 11.4 | 4.8 | −57% | 19 | 13 | −31% | 45 | 27 | −48% |
| | | (+41%) | | | (+8%) | | | (+17%) | |

With regard to the mechanical properties, it may be seen that the use of a latex has made it possible to reduce the loss of properties during ageing substantially, as well as to improve the level after ageing of each of the properties studied. The most remarkable improvements are in the puncture strength and tear strength.

Here again, it is surprising to note that the tear strength and the compressive strength (10% and 25%) are not improved, and are even slightly degraded, in the product immediately after its manufacture compared with the reference product. However, the incorporation of a latex makes the product much more stable over time in the sense that it suffers reductions in performance which are much less than in the reference product.

### EXAMPLES 2 and 3

The above observations were confirmed by reproducing Example 1 with two other phenol-formaldehyde resins R2 and R3 having slightly different characteristics from resin R1.

In each case, a corresponding reference product without latex was prepared. The results obtained are given in Table 2 below.

TABLE 2

| | Immersion | | | | Puncture strength | | |
|---|---|---|---|---|---|---|---|
| | water | Friability % | | | (N) | | |
| % latex/ | uptake | As | | | As | | |
| glass | kg/m³ | manufactured | Aged | Loss | manufactured | Aged | Loss |
| Example 2 | | | | | | | |
| 0%, | 23 | 3.2 | 21 | 17.8 | 188 | 59 | −69% |
| reference | | | | | | | |
| 2% Vinnol | 22 | 3.1 | 9.2 | 6.1 | 192 | 78 | −59% |
| | | | (−56%) | | | (+32%) | |
| Example 3 | | | | | | | |
| 0%, | 23 | 2.8 | 16.3 | 13.5 | 193 | 78 | −59% |
| reference | | | | | | | |
| 2% Vinnol | 20 | 3.4 | 11.1 | 7.7 | 189 | 113 | −40% |
| | | | (−32%) | | | (+45%) | |

| | Tear strength | | | 10% compressive | | | 25% compressive | | |
|---|---|---|---|---|---|---|---|---|---|
| | (kPa) | | | strength (kPa) | | | strength (kPa) | | |
| % latex/ | As | | | As | | | As | | |
| glass | manufactured | Aged | Loss | manufactured | Aged | Loss | manufactured | Aged | Loss |
| Example 2 | | | | | | | | | |
| 0%, | 10.7 | unmeas- | ≅−100% | 19 | 10 | −47% | 45 | 20 | −55% |
| reference | | urable | | | | | | | |
| 2% Vinnol | 8.9 | 3 | −66% | 17 | 16 | −6% | 41 | 24 | −56% |
| | | | | | (+16%) | | | (+20%) | |
| Example 3 | | | | | | | | | |
| 0%, | 12.6 | 4.6 | −63% | 20 | 13 | −36% | 49 | 26 | −47% |
| reference | | | | | | | | | |
| 2% Vinnol | 10.8 | 5.2 | −52% | 19 | 14 | −31% | 47 | 31 | −34% |
| | | (+13%) | | | (+8%) | | | (+19%) | |

This again shows an improvement in all the properties of the same order of magnitude as in Example 1. It should be noted that Example 3 reaches a very high general level of performance.

### EXAMPLES 4 and 5

These examples illustrate the repetition of Example 1 with other latices, respectively
Ex. 4: a vinyl acetate/methacrylic acid and ester copolymer having a minimum film-forming temperature of about 80° C. (solids content of approximately 50%, pH of about 8);
Ex. 5: a polyvinyl acetate homopolymer having a glass transition temperature of approximately 33° C. (solids content of approximately 55%; pH of about 4 to 5).

These two latices are based on a polymer in which each monomer carries hydrophilic functional groups. As is apparent from Table 3 below, the polyvinyl acetate homopolymer is very hydrophilic, which means that the insulation product has a high water absorption. The supplementary addition of a silicone as a water-repellent agent, at a very low content of about 0.2%, makes it possible to bring the absorption back to an acceptable level while maintaining the same improvement in the mechanical properties. The silicone may be substituted with a fluorinated-type water-repellent agent in order to reduce the water absorption while keeping the same advantageous level of mechanical properties.

TABLE 3

| | Immersion | | | | Puncture strength | | |
|---|---|---|---|---|---|---|---|
| % | water | Friability % | | | (N) | | |
| latex/ | uptake | As | | | As | | |
| glass | kg/m³ | manufactured | Aged | Loss | manufactured | Aged | Loss |
| Example 4 | | | | | | | |
| 0%, | 23 | 2.8 | 21.5 | 18.7 | 192 | 46 | −76% |
| reference | | | | | | | |
| 2% latex | 67 | 2.5 | 18.7 | 16.2 | 199 | 65 | −67% |
| | | | (−13%) | | | (+41%) | |
| Example 5 | | | | | | | |
| 0%, | 22 | 3.2 | 16.9 | 13.7 | 170 | 61 | −64% |
| reference | | | | | | | |
| 2% latex | 815 | — | — | — | — | — | — |
| 2% latex + | 35 | 2.6 | 8.6 | 6 | 197 | 112 | −43% |
| silicone | | | (−49%) | | | (+100%) | |

| | Tear strength | | | 10% compressive | | | 25% compressive | | |
|---|---|---|---|---|---|---|---|---|---|
| | (kPa) | | | strength (kPa) | | | strength (kPa) | | |
| % latex/ | As | | | As | | | As | | |
| glass | manufactured | Aged | Loss | manufactured | Aged | Loss | manufactured | Aged | Loss |
| Example 4 | | | | | | | | | |
| 0%, | 16 | 5 | −68% | 18.6 | 15.3 | −17% | 50.1 | 25 | −50% |
| reference | | | | | | | | | |
| 2% latex | 15.2 | 4.7 | −69% | 19.1 | 14.7 | −23% | 47 | 26.3 | −44% |
| | | (+6%) | | | (−4%) | | | (+5%) | |
| Example 5 | | | | | | | | | |
| 0%, | 14 | 3.7 | −81% | 19 | 12 | −36% | 46 | 22 | −52% |
| reference | | | | | | | | | |
| 2% latex + | 13 | 7.7 | −40% | 19 | 16 | −16% | 46 | 34 | −26% |
| silicone | | (+108% | | | (+33%) | | | (+54%) | |

It may be seen that the hydrophilic latex of Example 4 has a very favourable effect on the puncture strength and tear strength, and has a lesser effect on the compressive strength. The very hydrophilic latex of Example 5 turns out to have an excellent capability of improving all the properties studied after ageing, although the behaviour just after manufacture is not improved.

### EXAMPLE 6

Another insulation product is manufactured in the way indicated in Example 1 with the addition of 2% of latex, but with another glass (hereafter called G6) of the type described in WO-A-95/32927.

With this other glass, the addition of latex makes it possible to reduce the percentage loss of each of the properties studied. It will be noted in particular that there is a remarkable improvement in the puncture strength after ageing, which is actually twice the strength of the reference without a latex.

### EXAMPLE 7

Another insulation product is manufactured in the way indicated in Example 6, but with the polyvinyl acetate homopolymer latex used in Example 4, adding 1.5% of latex with respect to the weight of glass wool with 0.2% of silicone with respect to the weight of glass wool.

This hydrophilic latex makes it possible to achieve a more pronounced reduction in the percentage property loss than in Example 6. The level of each of the mechanical properties is furthermore raised considerably, with in particular a 250% improvement in the puncture strength and a more than 90% improvement in the tear strength.

### EXAMPLE 8

Another insulation product having a lower density of about 50 kg/m³ is manufactured under conditions which are otherwise identical to those in Example 2 (glass G1, resin R2, 2% of Vinnol latex).

In the case of this relatively light product, the mechanical strength is very markedly improved over the reference.

### EXAMPLES 9 and 10

Other insulation products having a density of about 50 kg/m³ are manufactured with glass G6 under conditions which are similar to those in Example 6 and are adapted in order to modify the density of the product, the addition of Vinnol latex being only 1%.

In Example 9, resin R2 is used with resin/urea proportions in a ratio of 55/45 and the addition of latex is carried out in the upper spray.

The general level of mechanical strength is raised significantly over the reference product.

In Example 10, resin R1 is used, always with resin/urea proportions in a ratio of 55/45, the latex being mixed into the size, everything being applied to the glass wool using a single spray ring.

These new conditions of applying the latex are also conducive to improving the mechanical strength after ageing.

The results obtained for the products in Examples 6 to 10 are shown in Table 5 below.

### EXAMPLES 11 and 12

As in Example 3, an insulation product having a density of approximately 80 kg/m³ is manufactured with resin R3, while adding only 1% of latex to the size by spraying with an upper ring and by using yet another glass (hereafter called G11) of the type described in WO-A-95/32927. Two new latices are used, namely:
Ex 11: a silanized styrene/acrylic ester copolymer sold by Wacker under the reference Vinnapas LL6030 (film-forming temperature of 24° C.);
Ex 12: a vinyl chloride/ethylene copolymer sold by Wacker under the reference Vinnol CE 752 (film-forming temperature of 7° C.). This is a hydrophobic latex.

These products are subjected to the same tests as those described above and the results are given in Table 4 below.

The invention, which has just been described in the particular case of insulation products based on glass wool of the type capable of dissolving in a physiological medium, is in no way limited to this embodiment. In particular, the latex may be used to improve the mechanical strength after ageing of products based on glasses that are less sensitive to exposure to water, or even products based on another mineral wool, such as rock wool. From the information given in the general description, those skilled in the art will be able to adapt the choice of materials depending on their particular requirements.

TABLE 4

| | Immersion | | | | Puncture strength | | |
|---|---|---|---|---|---|---|---|
| | water | Friability % | | | (N) | | |
| | uptake | As | | | As | | |
| | kg/m³ | manufactured | Aged | Loss | manufactured | Aged | Loss |
| 0%, | 18 | 1.2 | 16 | 14.8 | 277 | 41 | −85% |
| reference | | | | | | | |
| Example 11 | 16 | 1.5 | 10.9 | 9.4 | 221 | 57 | −74% |
| | | | (−32%) | | | (+39%) | |
| Example 12 | 11 | 1.3 | 11.1 | 9.4 | 229 | 47 | −79% |
| | | | (−30%) | | | (+15%) | |

| | Tear strength | | | 10% compressive | | | 25% compressive | | |
|---|---|---|---|---|---|---|---|---|---|
| | (kPa) | | | strength (kPa) | | | strength (kPa) | | |
| | As | | | As | | | As | | |
| | manufactured | Aged | Loss | manufactured | Aged | Loss | manufactured | Aged | Loss |
| 0%, | 21 | 7 | −67% | 26 | 18 | −32% | 55 | 23 | −58% |
| reference | | | | | | | | | |
| Example 11 | 18 | 6.5 | −63% | 24 | 17 | −30% | 51 | 25 | −51% |
| | | (−7%) | | | (−5%) | | | (+9%) | |
| Example 12 | 20 | 6 | −68% | 24 | 19 | −21% | 55 | 27 | −50% |
| | | (−14%) | | | (+5%) | | | (+17%) | |

TABLE 5

| | | | Puncture strength | | | | Tear strength | | |
|---|---|---|---|---|---|---|---|---|---|
| | Friability % | | (N) | | | | (kPa) | | |
| % latex/ | As | | | As | | | As | | |
| glass | manufactured | Aged | Loss | manufactured | Aged | Loss | manufactured | Aged | Loss |
| Example 6 | | | | | | | | | |
| 0%, reference | 4.7 | 20.5 | 15.8 | 127 | 36 | −72% | 15.1 | 6 | −60% |
| 2% latex | 5.1 | 13.2 | 8.1 | 143 | 72 | −50% | 12 | 6.8 | −43% |
| | | (−36%) | | | (+100%) | | | (+13%) | |
| Example 7 | | | | | | | | | |
| 0%, reference | 4.7 | 20.5 | 15.8 | 127 | 36 | −72% | 15.1 | 6 | −60% |
| 1.5% latex | 2.6 | 5.4 | 2.8 | 176 | 128 | −29% | 13.8 | 11.6 | −16% |
| | | (−74%) | | | (+255%) | | | (+93%) | |
| Example 8 | | | | | | | | | |
| 0%, reference | 2.2 | 8.6 | 6.4 | 90 | 30 | −66% | 8.4 | 4.7 | −44% |
| 2% latex | 2.3 | 4.0 | 1.7 | 90 | 55 | −39% | 5.9 | 3.9 | −34% |
| | | | | | (+83%) | | | (+85%) | |
| Example 9 | | | | | | | | | |
| 0%, reference | 2.0 | 7.4 | 5.4 | 100 | 40 | −60% | 10.7 | 3.9 | −63% |
| 1% latex | 2.0 | 4.7 | 2.7 | 95 | 55 | −42% | 10.3 | 7.9 | −23% |
| | | | | | (37%) | | | (+102%) | |
| Example 10 | | | | | | | | | |
| 0%, reference | 1.3 | 8.1 | 6.8 | 100 | 55 | −55% | 7.5 | 2.5 | −67% |
| 1% latex | 1.4 | 5.1 | 3.7 | 95 | 60 | −36% | 6.8 | 2.9 | −57% |
| | | | | | (+9%) | | | (+16%) | |

| | 10% compressive | | | 25% compressive strengt | | |
|---|---|---|---|---|---|---|
| | strength (kPa) | | | (kPa) | | |
| % latex/ | As | | | As | | |
| glass | manufactured | Aged | Loss | manufactured | Aged | Loss |
| Example 6 | | | | | | |
| 0%, reference | 22 | 17 | −23% | 47 | 28 | −40% |
| 2% latex | 20 | 16.8 | −16% | 42.5 | 29 | −31% |
| | | (−1%) | | | (+3%) | |
| Example 7 | | | | | | |
| 0%, reference | 22 | 17 | −23% | 47 | 28 | −40% |
| 1.5% latex | 25 | 21.7 | −13% | 50 | 39 | −22% |
| | | (+28%) | | | (+39%) | |
| Example 8 | | | | | | |
| 0%, reference | 12 | 7.1 | −41% | 23 | 11 | −52% |
| 2% latex | 10.4 | 8 | −18% | 20 | 14 | −30% |
| | | (+18%) | | | (+27%) | |
| Example 9 | | | | | | |
| 0%, reference | 15.3 | 11 | −28% | 27 | 17 | −37% |
| 1% latex | 15.1 | 14 | −7% | 28 | 21 | −25% |
| | | (+27%) | | | (+23%) | |
| Example 10 | | | | | | |
| 0%, reference | 11.4 | 8.4 | −26% | 23 | 13 | −43% |
| 1% latex | 11.7 | 9.0 | −23% | 22 | 15 | −32% |
| | | (+7%) | | | (+15%) | |

1. A method of improving the mechanical strength after ageing of an insulation product comprising mineral wool, comprising:
melting a glass or rock mineral composition,
fiberizing the molten glass or mineral composition into filaments to form a mineral wool,
applying a size comprising a thermosetting resin to the mineral wool which has just been formed,
simultaneously or sequentially applying a hydrophilic latex to the mineral wool, then
taking up the sized mineral wool in the form of a web, and then
thermally curing the size,
wherein the hydrophilic latex comprises the following (1) or (2), wherein (1) is a dispersion or emulsion of homopolymer or copolymer prepared from one or more monomers each having at least one hydrophilic functional group selected from the group consisting of hydroxyl, carboxyl and ester, and
(2) is a dispersion or emulsion of a silanized or non-silanized vinyl chloride/vinyl laurate/ethylene terpolymer and a protective colloid having hydrophilic functional groups selected from the group consisting of polyvinyl alcohol and cellulose.

2. The method according to claim 1, wherein the mineral wool dissolves in a physiological medium.

3. The method according to claim 1, wherein the homopolymer or copolymer is selected from the group consisting of vinyl acetate homopolymers or copolymers, acrylic polymers and carboxylic acid containing polymers.

4. The method according to claim 3, wherein the homopolymer or copolymer is selected from the group consisting of a polyvinyl acetate homopolymer, a vinyl acetate/(meth) acrylic acid or ester copolymer, and a vinyl acetate/maleic ester copolymer.

5-6. (canceled)

7. The method according to claim 1, wherein the latex further comprises a water-repellent agent.

8. The method according to claim 1, wherein the homopolymer, copolymer or terpolymer has a glass transition temperature Tg of less than 80° C.

9. The method according to claim 1, wherein the homopolymer, copolymer or terpolymer has a glass transition temperature Tg of greater than −5° C.

10. The method according to claim 1, wherein after said curing, the solids content of the hydrophilic latex is less than 5% by weight with respect to the weight of mineral wool.

11. The method according to claim 1, wherein the hydrophilic latex is mixed with the size before application to the mineral wool.

12. The method according to claim 1, wherein the hydrophilic latex is applied to the mineral wool separately from the size.

13. An insulation product prepared by
melting a glass or rock mineral composition,
fiberizing the molten glass or mineral composition into filaments to form a mineral wool,
applying a size comprising a thermosetting resin to the mineral wool which has just been formed,
simultaneously or sequentially applying a hydrophilic latex to the mineral wool, then
taking up the sized mineral wool in the form of a web, and then
thermally curing the size,
wherein the hydrophilic latex comprises the following (1) or (2), wherein (1) is a dispersion or emulsion of homopolymer or copolymer prepared from one or more monomers each having at least one hydrophilic functional group selected from the group consisting of hydroxyl, carboxyl and ester, and
(2) is a dispersion or emulsion of a silanized or non-silanized vinyl chloride/vinyl laurate/ethylene terpolymer and a protective colloid having hydrophilic functional groups selected from the group consisting of polyvinyl alcohol and cellulose.

14. The insulation product according to claim 13, wherein the mineral wool comprises glass or rock wool which dissolves in a physiological medium.

15. The insulation product according to claim 14, wherein the mineral wool dissolves in a saline solution simulating a physiological medium at a rate of at least 30 ng/cm² per hour, measured at pH 4.5, and at a rate of at least 30 ng/cm² per hour, measured at pH 7.5.

16. The insulation product according to claim 13, wherein the insulation product has a density of at least 30 kg/m³.

17. The insulation product of claim 13, wherein the insulation product is a thermal and/or acoustic insulation product.

18. A sizing composition comprising a phenolic resin and a hydrophilic latex,
wherein the hydrophilic latex comprises the following (1) or (2), wherein (1) is a dispersion or emulsion of homopolymer or copolymer prepared from one or more monomers each having at least one hydrophilic functional group selected from the group consisting of hydroxyl, carboxyl and ester, and
(2) is a dispersion or emulsion of a silanized or non-silanized vinyl chloride/vinyl laurate/ethylene terpolymer and a protective colloid having hydrophilic functional groups selected from the group consisting of polyvinyl alcohol and cellulose.

19. The method of claim 7, wherein the water repellent agent is a silicone or a fluorinated compound.

20. The method of claim 8, wherein the homopolymer, copolymer or terpolymer has a glass transition temperature Tg of less than 50° C.

21. The method of claim 9, wherein the homopolymer, copolymer or terpolymer has a glass transition temperature Tg of greater than 0° C.

22. The method of claim 10, wherein the solids content of the hydrophilic latex is about 0.01 to 5% by weight with respect to the weight of the mineral wool.

23. The method of claim 1, wherein the thermosetting resin is a phenolic resin.

24. The insulation product of claim 13, wherein the thermosetting resin is a phenolic resin.

25. The insulation product of claim 16, wherein the density is at least 80 kg/m³.

26-27. (canceled)

28. The method of claim 2, wherein the mineral wool comprises 8 to 25% by weight of at least one alkali metal oxide.

29. (canceled)

30. The insulation product of claim 15, wherein the mineral wool dissolves in a saline solution simulating a physiological medium at a rate of at least 40 ng/cm² per hour, measured at pH 4.5, and at a rate of at least 40 ng/cm² per hour, measured at pH 7.5.

31. The insulation product of claim 15, wherein the mineral wool dissolves in a saline solution simulating a physiological medium at a rate of at least 50 ng/cm² per hour, measured at pH 4.5, and at a rate of at least 50 ng/cm² per hour, measured at pH 7.5.

32. The insulation product according to claim 13, wherein the insulation product has a density of at least 50 kg/m³.

33. The method according to claim 1, wherein the hydrophilic latex comprises (1).

34. The method according to claim 1, wherein the hydrophilic latex comprises (2).

35. The insulation product according to claim 13, wherein the hydrophilic latex comprises (1).

36. The insulation product according to claim 13, wherein the hydrophilic latex comprises (2).

37. The sizing composition according to claim 18, wherein the hydrophilic latex comprises (1).

38. The sizing composition according to claim 18, wherein the hydrophilic latex comprises (2).
